(19) United States
(12) Patent Application Publication
(10) Pub. No.: US 2007/0104912 A1
(43) Pub. Date: May 10, 2007

(54) Constructed strip-off type adhesive tape set

(76) Inventor: Shen-Nan Kan, Taipei Hsien (TW)

Correspondence Address: TROXELL LAW OFFICE PLLC, SUITE 1404, 5205 LEESBURG PIKE, FALLS CHURCH, VA, 22401, US

(21) Appl. No.: 11/269,726

(22) Filed: Nov. 9, 2005

(51) Int. Cl. B32B 33/00

(52) U.S. Cl. 428/40.1

(57) ABSTRACT

A constructed strip-off type adhesive tape set including a plurality of adhesive tape packs, an annular member and an adhesive-tape stand, wherein each of the adhesive tape packs is composed at least of a strip-off type adhesive tape piece and a seat for receiving the adhesive tape piece, the seat has on each of its two mutually opposite lateral sides an engaging part, the annular member is provided in a spaced way thereon with a plurality of inserting sockets for inserting of the engaging parts of the seat, hence the adhesive tape packs can be received on the annular member; the adhesive-tape stand includes a main seat and an engaging seat adapted to engaging with each other, wherein the main seat has a cylinder, in order that when the annular member is placed over the cylinder, the annular member is sandwiched between the main seat and the engaging seat, and can be rotated on the cylinder.

### BACKGROUND OF THE INVENTION

1. Field of the Invention

The present invention relates to a constructed strip-off type adhesive tape set, and more particularly to a strip-off type adhesive tape set allowing placing thereon changeable strip-off type adhesive tapes of various widths and lengths, the tape set is structurally simple, convenient for assembling and use, and is applicable to use for various strip-off type adhesive tapes in combination.

2. Description of the Prior Art

Adhesive tapes have been popularized to be necessities in our lives, and have been used in large amount in the working places such as the businesses of ready-made clothes, general merchandises, and in offices etc. for the purposes of packing with plastic bags, packing for stationeries and gifts. Adhesive tapes therefore provide the functions of sticking, packing, fixing and marking. However, in use, a user often feels cumbersome in cutting tapes or deciding the to be cut lengths of tapes. In particular, an action of cutting the tapes requires a knife or a sharp article; if there is no such auxiliary tools available, cutting adhesive tapes will be difficult, and if the user forcedly tears up the adhesive tapes, the area of tearing will become ugly.

Thereby, to overcome the above defect, a design for a strip-off type adhesive tape in the market. When a user tears a first adhesive tape piece, a second adhesive tape piece therebeneath can be brought up by a sticking force to reveal an end with no adhesive of the second adhesive tape piece for the convenience of tearing by the user; however, the amount of the adhesive tape pieces in designing is not large, this is inconvenient and uneconomic for those shops needing many adhesive tape pieces. Further, there is no suitable adhesive tape set for placing the strip-off type adhesive tape.

### SUMMARY OF THE INVENTION

The primary objective of the present invention is to provide a constructed strip-off type adhesive tape set which is structurally simple, convenient for assembling and use, and allows placing thereon various changeable strip-off type adhesive tapes.

To achieve the above objective, in the present invention, the constructed strip-off type adhesive tape set includes a plurality of adhesive tape packs, an annular member and an adhesive-tape stand; wherein each of the adhesive tape packs is composed at least of a strip-off type adhesive tape piece and a seat for receiving the adhesive tape piece, the seat has on each of its two mutually opposite lateral sides an engaging part, the annular member is provided in a spaced way thereon with a plurality of inserting sockets for inserting of the engaging parts of the seat; hence the adhesive tape packs can be received on the annular member; the adhesive-tape stand includes a main seat and an engaging seat adapted to engaging with each other, wherein the main seat has a cylinder, in order that when the annular member is placed over the cylinder, the annular member is sandwiched between the main seat and the engaging seat, and can be rotated on the cylinder.

The present invention will be apparent in its constructional content and effects to be obtained after reading the detailed description of the preferred embodiment thereof in reference to the accompanying drawings.

### BRIEF DESCRIPTION OF THE DRAWINGS

FIG. 1 is an exploded perspective view showing elements of an embodiment of the constructed strip-off type adhesive tape set of the present invention;

FIG. 2 is a perspective view showing the appearance of the embodiment of the constructed strip-off type adhesive tape set of the present invention after assembling;

FIG. 3 is a sectional view of the embodiment of the constructed strip-off type adhesive tape set of the present invention after assembling;

FIG. 4 is a sectional schematic view showing use of the embodiment of the present invention in taking a tape piece;

FIG. 5 is another sectional schematic view showing use of the embodiment of the present invention in taking a tape piece;

FIG. 6 is an exploded perspective view showing elements of another embodiment of the present invention after assembling; and

FIG. 7 is a perspective view showing the appearance of the other embodiment of the constructed strip-off type adhesive tape set of the present invention after assembling.

### DETAILED DESCRIPTION OF THE PREFERRED EMBODIMENT

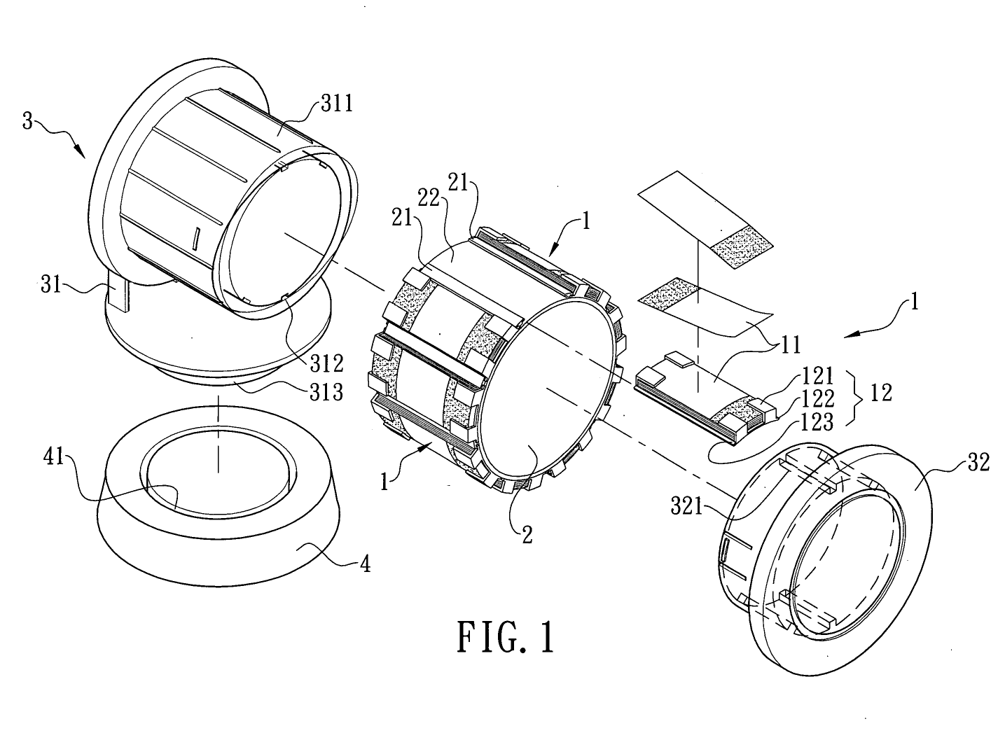

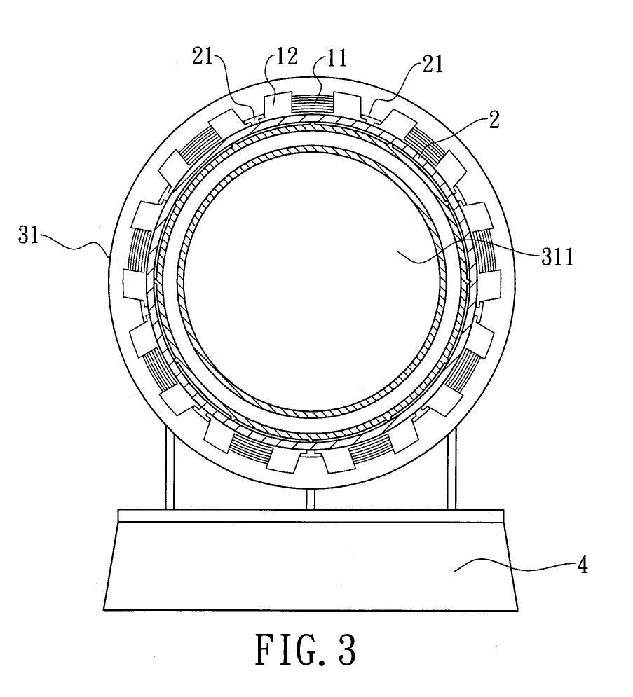

Referring to FIGS. 1-3 showing an embodiment of the constructed strip-off type adhesive tape set of the present invention, the tape set comprises a plurality of adhesive tape packs 1, an annular member 2 and an adhesive-tape stand 3.

Each of the adhesive tape packs 1 is composed at least of a strip-off type adhesive tape piece 11, and a seat 12 for receiving the adhesive tape piece 11, the seat 12 has thereon pressing portions 121 to firmly hold the adhesive tape packs 1, the amount of the pressing portions 121 is four, the pressing portions 121 are respectively provided on the four corners of the seat 12, and the seat 12 has on its two mutually opposite lateral sides two engaging parts 122, 123.

The annular member 2 is provided in a spaced way thereon with a plurality of “T” shaped posts 21, an inserting socket 22 is provided between every two “T” shaped posts 21 for inserting of the engaging parts 122, 123 of the seat 12 therein, hence the adhesive tape packs 1 can be received on the annular member 2.

The adhesive-tape stand 3 includes a main seat 31 and an engaging seat 32 adapted to engaging with each other, wherein the main seat 31 has a cylinder 311 in order that the annular member 2 can be placed over the cylinder 311; the cylinder 311 is provided thereon with a connecting member 312, while the engaging seat 32 is provided thereon with a connecting portion 321 in corresponding to the connecting member 312 on the cylinder 311.

When in practicing, referring to FIG. 5, the engaging parts 122, 123 of the seat 12 of each adhesive tape pack 1 are firstly inserted into an inserting socket 22 provided between two “T” shaped posts 21, so that the adhesive tape pack 1 can be received on the annular member 2. And after the annular member 2 is slipped over the cylinder 311, the connecting portion 321 of the engaging seat 32 is engaged with the connecting member 312 of the cylinder 311; then the annular member 2 is sandwiched between the main seat 31 and the engaging seat 32, and can be rotated on the cylinder 311.

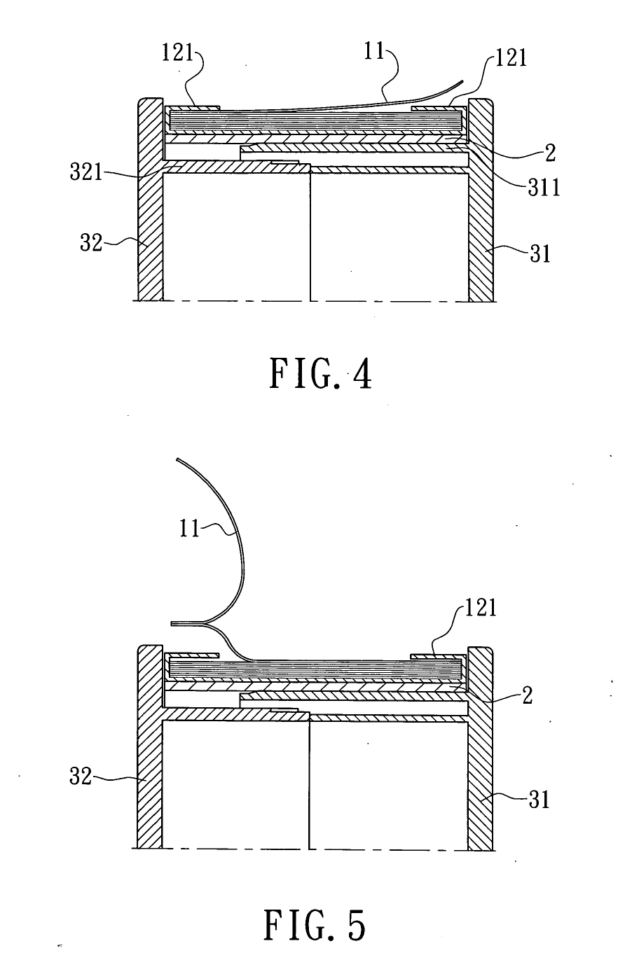

Thereby, a user can take a strip-off type adhesive tape piece 11 in this one adhesive tape pack 1 received on the annular member 2; when one end of the adhesive tape piece 11 is torn off, the other end (the tailing end) of the adhesive tape piece 11 can be lifted to lift the subsequent adhesive tape piece 11 (as shown in FIGS. 4 and 5); and one end of the subsequent adhesive tape piece 11 lifted can be exactly exposed out of a pressing portion 121 of the seat 12. And more, the adhesive tape pieces 11 in the adhesive tape pack 1 can be of various colors, kinds or types for using at the user's will; the annular member 2 can be rotated on the cylinder 311 in favor of more convenient choosing by the user; when the adhesive tape pieces 11 in the adhesive tape pack 1 are exhausted, it needs only to separate the main seat 31 from the engaging seat 32 to remove the annular member 2 for supplementing an adhesive tape pack 1 required on the annular member 2, and adhesive tape pieces 11 can be provided at once for use after assembling.

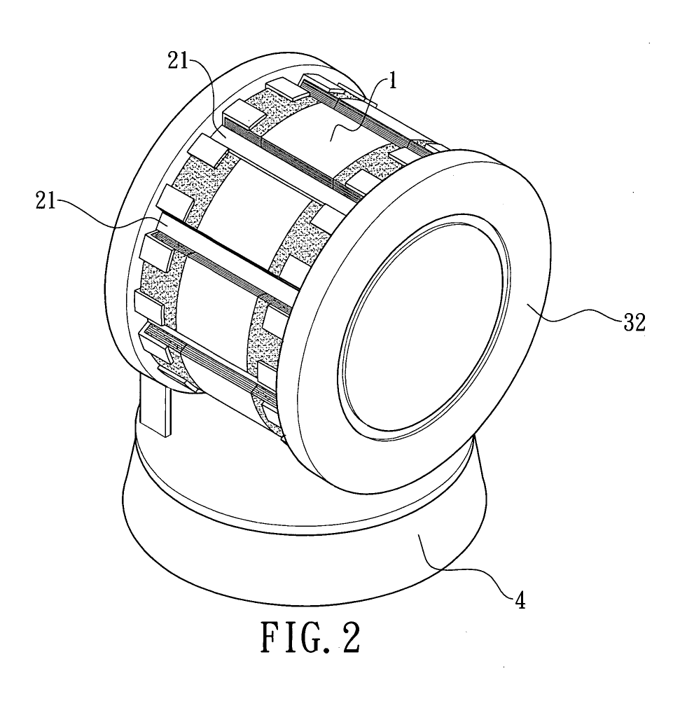

More over, referring to FIGS. 1 and 2, the present invention further is provided with a base 4 for connecting of the abovementioned adhesive-tape stand 3 thereto, wherein the base 4 is provided thereon with a circular recess 41, the main seat 31 is provided on its bottom with a circular protrusion 313 in coincidence in shape with the circular recess 41, so that when the circular protrusion 313 is connected with the circular recess 41, the main seat 31 can be rotated on the base 4 for 360 degrees.

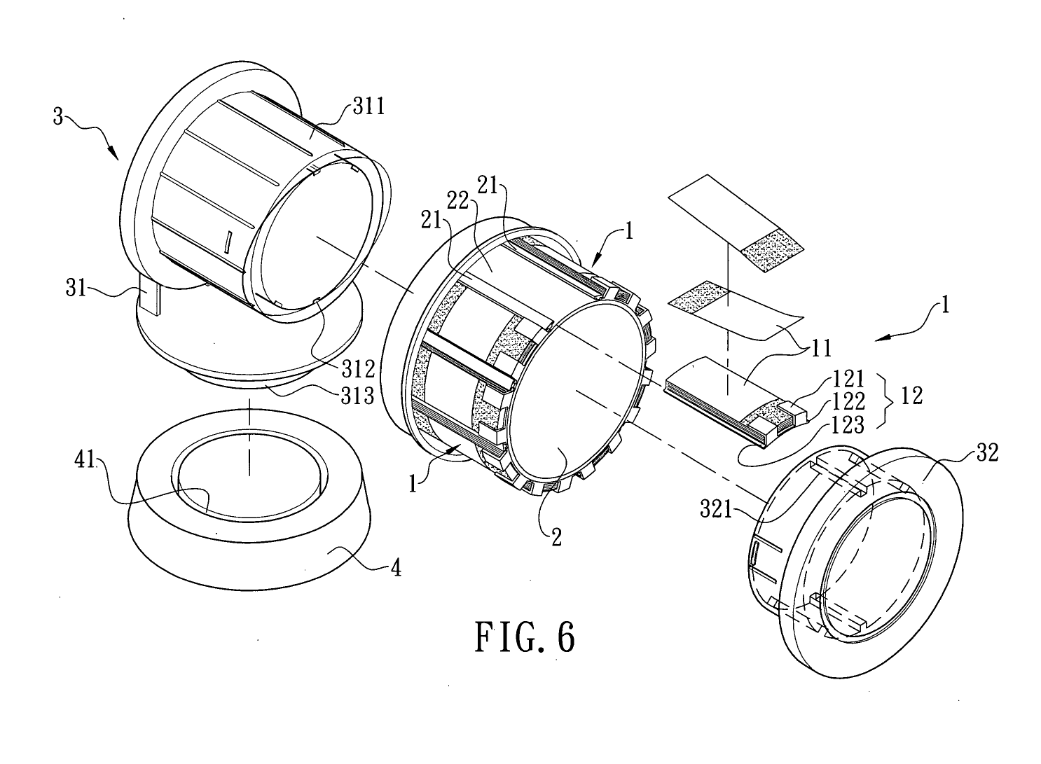

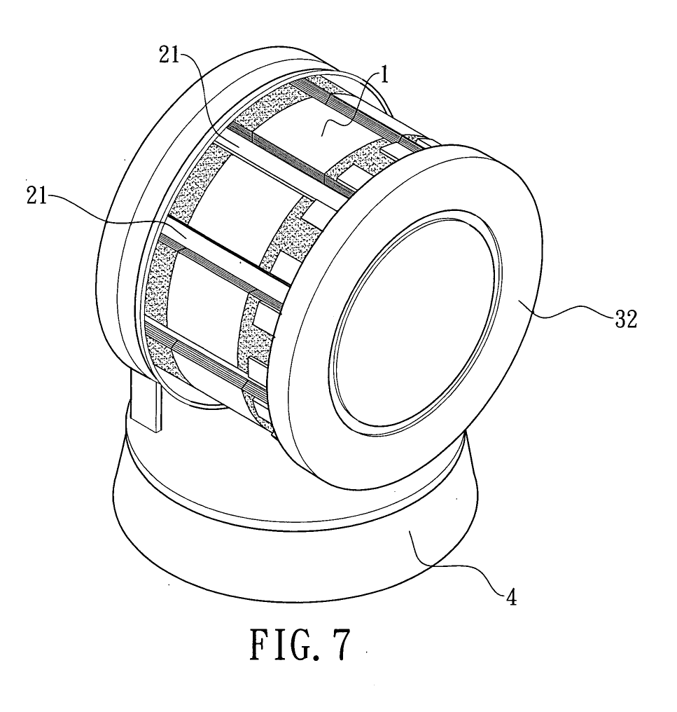

And please refer to FIGS. 6 and 7 showing another embodiment of the present invention, wherein there are two pressing portions 121 respectively provided on two lateral sides of the seat 12, while the annular member 2 is provided on one end thereof with an “L” shaped lip 23, so that when the seat 12 is inserted into an inserting socket 22 of the annular member 2, the two pressing portions 121 are exactly opposite to the lip 23; and thereby when one end of the adhesive tape piece 11 is torn off, the other end (the tailing end) of the adhesive tape piece 11 can be lifted to lift the subsequent adhesive tape piece 11 to be exposed out of the lip 23 of the annular member 2, thus similarly, an object of conveniently and continuously taking the tapes for use can be achieved.

The present invention thereby has the following advantages:

1. The constructed strip-off type adhesive tape set in the present invention allows adhesive tape pieces of various colors, kinds or types to be inserted directly in the annular member to render more convenient and more multivariate use of a user.

2. The constructed strip-off type adhesive tape set in the present invention is structurally simple, convenient for assembling, the adhesive tape piece wanted can be taken out just by rotating the annular member, if an adhesive tape pack is exhausted, the annular member can be detached for supplementing a new adhesive tape pack, this is very convenient.

In conclusion, as are stated and shown in the above disclosed and depicted, the present invention can surely attain its expected object to provide a constructed strip-off type adhesive tape set. The above stated are embodiments and the technical measures used in the present invention; it will be apparent to those skilled in this art that various modifications or changes can be made to the elements of the present invention without departing from the spirit and scope of this invention; all such modifications and changes shall fall within the scope of the appended claims and are intended to form part of this invention.

1. A constructed strip-off type adhesive tape set comprising:
a plurality of adhesive tape packs, each of said adhesive tape packs is composed at least of a strip-off type adhesive tape piece and a seat for receiving said adhesive tape piece, wherein said seat has on each of its two mutually opposite lateral sides an engaging part;
an annular member provided in a spaced way thereon with a plurality of inserting sockets for inserting of said engaging parts of said seat, hence said adhesive tape packs being adapted to receiving on said annular member; and
an adhesive-tape stand including a main seat and an engaging seat adapted to engaging with each other, wherein said main seat has a cylinder, in order that when said annular member is placed over said cylinder, said annular member is sandwiched between said main seat and said engaging seat, and is adapted to rotating on said cylinder.

2. The constructed strip-off type adhesive tape set as in claim 1, wherein said seat has thereon pressing portions to firmly hold said adhesive tape packs.

3. The constructed strip-off type adhesive tape set as in claim 2, wherein the amount of said pressing portions is four, said pressing portions are respectively provided on four corners of said seat.

4. The constructed strip-off type adhesive tape set as in claim 2, wherein amount of said pressing portions is two, said pressing portions are respectively provided on two lateral sides of said seat, a side of said annular member is provided on one end thereof with an “L” shaped lip, so that when said seat is inserted into one of said inserting sockets of said annular member, said two pressing portions are exactly opposite to said lip.

5. The constructed strip-off type adhesive tape set as in claim 1, wherein said annular member is provided in a spaced way thereon with a plurality of “T” shaped posts, one of said inserting sockets is provided between every two “T” shaped posts.

6. The constructed strip-off type adhesive tape set as in claim 1, wherein said cylinder of said main seat is provided thereon with a connecting member, while said engaging seat is provided thereon with a connecting portion in corresponding to said connecting member on said cylinder for mutual engaging.

7. The constructed strip-off type adhesive tape set as in claim 1, wherein said adhesive tape set is provided with a base for connecting of said adhesive-tape stand thereto.

8. The constructed strip-off type adhesive tape set as in claim 7, wherein said base is provided thereon with a circular recess, said main seat is provided on its bottom with a circular protrusion in coincidence in shape with said circular recess, so that when said circular protrusion is connected with said circular recess, said main seat is adapted for rotating on said base for 360 degrees.
